(19) United States
(12) Patent Application Publication
(10) Pub. No.: US 2012/0004784 A1
(43) Pub. Date: Jan. 5, 2012

(54) APPARATUS AND METHOD FOR ENERGY MANAGEMENT

(75) Inventors: Jung Hwan OH, Seoul (KR); Jae Seong Park, Daejeon (KR); Dong Min Son, Suwon (KR)

(73) Assignee: LSIS., LTD.

(21) Appl. No.: 13/165,682

(22) Filed: Jun. 21, 2011

(30) Foreign Application Priority Data
Jul. 2, 2010 (KR) 10-2010-0063995

(51) Int. Cl. G06F 1/26

(52) U.S. Cl. 700/291

(57) ABSTRACT

Apparatus and method for energy management are disclosed. An operating state of each energy consumption device is estimated by detecting a variation in total energy consumption amount per unit time using a meter and then comparing the variation with a previously inputted energy consumption amount per unit time for each of the energy consumption devices. If the operating state of each of the energy consumption devices is estimated, it is possible to detect the consumption time and power consumption amount for each of the energy consumption devices, thereby predicting a current or future energy consumption rate. The predicted result is applied in various manners so as to effectively use energy.

### CROSS-REFERENCE TO RELATED APPLICATION

This application claims the benefit of Korean Patent Application No. 10-2010-0063995, filed Jul. 2, 2010, the disclosure of which is hereby incorporated herein by reference in its entirety.

### BACKGROUND OF THE INVENTION

1. Field of the Invention

An aspect of the present invention relates to an apparatus and method for energy management, and more specifically, to an apparatus and method for energy management, which enables a user to reasonably use energy through an approach of predicting the energy consumption rate of an individual device in concert with recent trend for effective use of limited energy resources in the smart grid society in which the energy price is changed depending on time.

2. Description of the Prior Art

Up to the present, various energies such as electricity, gas and water have been supplied according to the maximum demand, and the energy price has been fixed thereupon.

However, a plan for differentiating the energy price for each time zone or season has recently been conceived for more effective use of limited energy resources and reduction of energy consumption.

A smart grid or smart meter has come into the spotlight as a technology for promoting an effective use of energy.

The smart grid is a next-generation power network that can optimize energy efficiency and create a new added value by enabling customers to bidirectionally exchange real-time information with each other through combination of information technology (IT) with a power network.

In a user point of view, the smart grid is to use energy in the most reasonable time zone according to changes in price of the energy.

The smart meter refers to a digital watt-hour meter to which a communication function is added. The smart meter can perform real-time examination of the amount of power used or bidirectional communication between a power provider and a customer.

Thus, the remote and real-time inspection of a meter is possible without meterman's visiting a household, and hence the smart meter can precisely measure the amount of power used. Accordingly, the smart meter can obtain such advantageous effects such as saving of metering cost and energy.

Meanwhile, in order to more effectively use energy in the smart grid society, not only energy use information but also grasp of individual state of each energy consumption device placed in an energy consumption place should be detected.

Particularly, the greatest interest of users is to save energy consumption rates. Therefore, in order to individually deal with energy consumption devices in the user point of view, it is required to individually detect the energy consumption rate of each of the energy consumption devices placed in an energy consumption place.

### SUMMARY OF THE INVENTION

Embodiments of the present invention provide an apparatus and method for energy management, which controls a load by estimating an operating state of each energy consumption device using energy consumption amount information detected in a meter and predicting a current or future energy consumption rate for an individual energy consumption device through the estimated operating state, so that it is possible to allow a user to more effectively use energy.

According to an aspect of the present invention, there is provided an apparatus for energy management, the apparatus including: an estimation component configured to estimate an operating state of an individual energy consumption device based on an energy variation according to time, detected by a meter; an analysis component configured to analyze a power consumption amount of the individual energy consumption device base on an analysis of the consumption time of the individual energy consumption device; a reception component configured to receive energy price information according to time from a central server; and a prediction component configured to predict an energy consumption rate of the individual energy consumption device based on the power consumption amount of the individual energy consumption device and the energy price information.

Preferably, the apparatus further includes an energy control component configured to supply or cut off energy to or from the individual energy consumption device based on a predicted result of the prediction component.

Preferably, the energy control component directly controls power of an energy consumption device or may control an outlet to which the energy consumption device is connected.

Preferably, the energy control component transmits a control result for the energy consumption device to at least one of a user portable terminal and an in home display (IHD).

Preferably, the prediction component transmits the predicted energy consumption rate of the individual energy consumption device and a total energy consumption rate to at least one of the central server, the user portable terminal and the IHD.

Preferably, the prediction component monitors whether or not at least one of the predicted energy consumption rate of the individual energy consumption device and the total energy consumption rate exceeds a predetermined maximum value.

Preferably, the estimation component transmits a warning message to at least one of the user portable terminal and the IHD based on a monitored result.

According to another aspect of the present invention, there is provided a method for energy management, the method including: estimating an operating state of an individual energy consumption device based on an energy variation according to time, detected by a meter; analyzing a power consumption amount of the individual energy consumption device base on an analysis of the consumption time of the individual energy consumption device; receiving energy price information according to time from a central server; and predicting an energy consumption rate of the individual energy consumption device based on the power consumption amount of the individual energy consumption device and the energy price information.

Preferably, the method further includes controlling energy by supplying or cutting off the energy to or from the individual energy consumption device based on a predicted result.

Preferably, the controlling of the energy directly controls power of an energy consumption device or may control an outlet to which the energy consumption device is connected.

Preferably, the controlling of the energy transmits a control result for the energy consumption device to at least one of a user portable terminal and an IHD.

Preferably, the predicted energy consumption rate of the individual energy consumption device and a total energy consumption rate are transmitted to at least one of the central server, the user portable terminal and the IHD.

When the predicted energy consumption rate of the individual energy consumption device exceeds a predetermined maximum value, a warning message is preferably transmitted to at least one of the user portable terminal and the IHD based on a monitored result.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 shows an embodiment of a system for energy management according to the present invention;

FIG. 2 shows another embodiment of a system for energy management according to the present invention;

FIGS. 3 to 8 show examples illustrating a method for estimating an operating state of each energy consumption device related to the present invention;

FIG. 9 shows an example illustrating an estimation component;

FIG. 10 shows an example of an energy price structure;

FIGS. 11 to 14 show various examples of a method for predicting a future energy consumption rate;

FIG. 15 shows an example illustrating an energy control component;

FIGS. 16 and 17 show various examples related to a structure in which the energy control component controls energy consumption devices;

FIGS. 18 and 19 show an embodiment of an apparatus for energy management according to the present invention;

FIG. 20 shows a specific embodiment of the for energy management according to the present invention;

FIGS. 21 and 22 show an example of a display screen on which energy management information is displayed; and

FIGS. 23 and 24 show embodiments of a method for energy management according to the present invention.

### DETAILED DESCRIPTION OF PREFERRED EMBODIMENTS

Hereinafter, preferred embodiments of the present invention will be described in detail with reference to the accompanying drawings. However, the present invention is not limited to the embodiments but may be implemented into different forms. These embodiments are provided only for illustrative purposes and for full understanding of the scope of the present invention by those skilled in the art. Further, the terms used in the description are defined considering the functions of the present invention and may vary depending on the intention or usual practice of a user or operator. Therefore, the definitions should be made based on the entire contents of the description.

Energy refers to electric energy in the present invention.

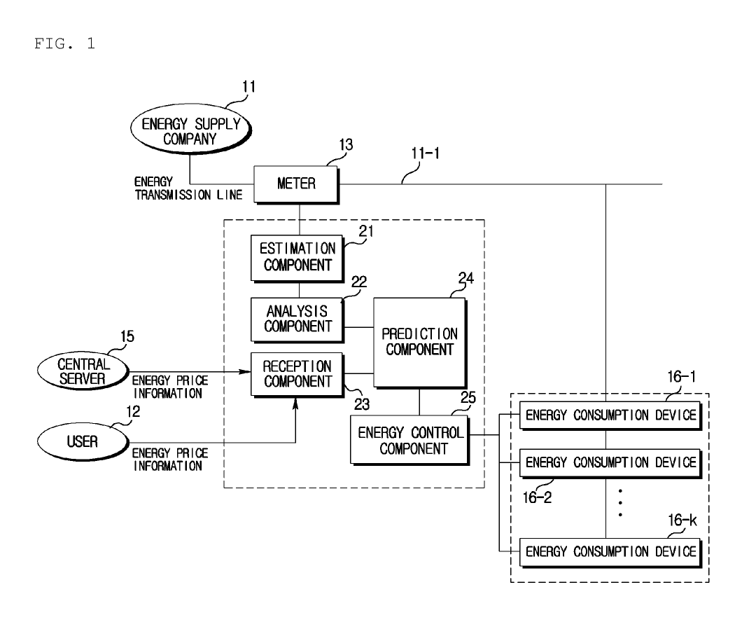

Referring to FIG. 1, electric energy supplied by an energy supply company 11 is supplied to an energy consumption place along an energy transmission line 11-1 so as to be used by energy consumption devices 16-1 to 16-k.

The energy consumption devices 16-1 to 16-k are devices that operate using the electric energy, such as a refrigerator, a television (TV) set, a heating device, a cooling device and an illuminator.

A meter 13 is installed in the energy consumption place.

The meter 13 refers to an electronic gauge that detects information on energy, such as energy consumption amount, used through the energy consumption devices 16-1 to 16-k.

A system for energy management according to the present invention includes at least an estimation component 21, an analysis component 22, a reception component 23 and a prediction component 24.

In the system for energy management, one or more estimation components 21, the analysis component 22, the reception component 23 and the prediction component 24 may be integrally configured in the same apparatus so as to perform its function while communicating with the other components.

In the system for energy management, the function of one or more of the estimation component 21, the analysis component 22, the reception component 23 and the prediction component 24 may be configured to be performed by the meter 13.

The system for energy management may further include an energy control component 25. The energy control component 25 controls the energy consumption devices 16-1 to 16-k based on the estimated result of the estimation component 24.

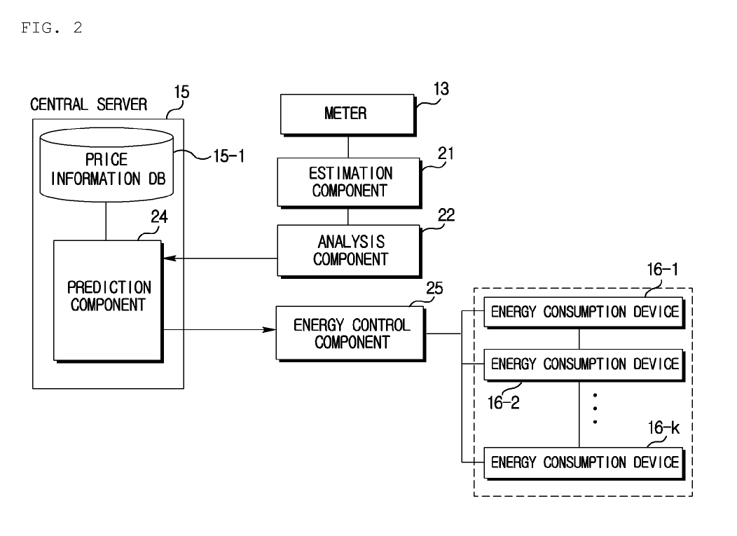

Referring to FIG. 2, a central server 15 may be configured to perform the function of the prediction component 24. The central server 15 is a server through which the energy supply company 11 provides services related to energy. The central server 15 may transmit energy price information through various communication networks such as a wireless mesh network, a power line communication network and an Internet network.

The estimation component 21 estimates an operating state of each of the energy consumption devices 16-1 to 16-k, e.g., which energy consumption device is under operation, based on an energy variation according to the time, detected by the meter 13.

To this end, the estimation component 21 maintains information on the energy consumption amount per unit time for each of the energy consumption devices. The information may be previously inputted in the manufacture of the system, or may be configured to be inputted by a user.

In the latter case, the estimation component 21 may provide a user interface (UI) that enables the user to input the information on the energy consumption amount per unit time for each of the energy consumption device, or may receive information inputted by the user from another device.

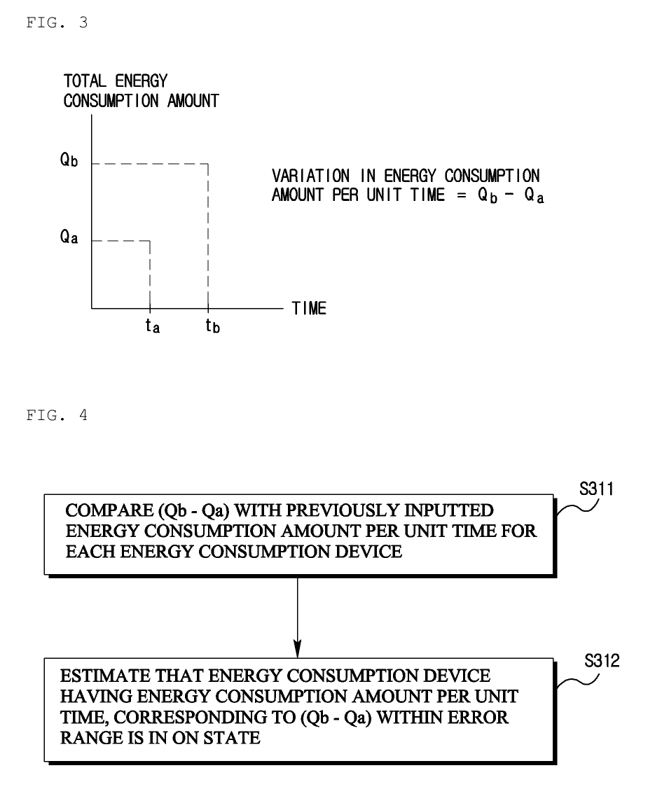

A method for estimating an operating state of each of the energy consumption devices based on an energy variation according to the time detected by the meter 13 (specifically, the total energy consumption amount per unit time) will be described with reference to FIG. 3 to 6.

Referring to FIG. 3, when the total energy consumption amount detected at a time ‘ta’ by the meter 13 is ‘Qa’, the total energy consumption amount detected at another time ‘tb’ by the meter 13 is ‘Qb’, and ‘tb−ta’ is a unit time, the variation in the total energy consumption amount per unit time becomes ‘Qb−Qa’. In this instance, Qb>Qa.

The variation in the total energy consumption amount per unit time means that the energy consumption device under operation has been changed.

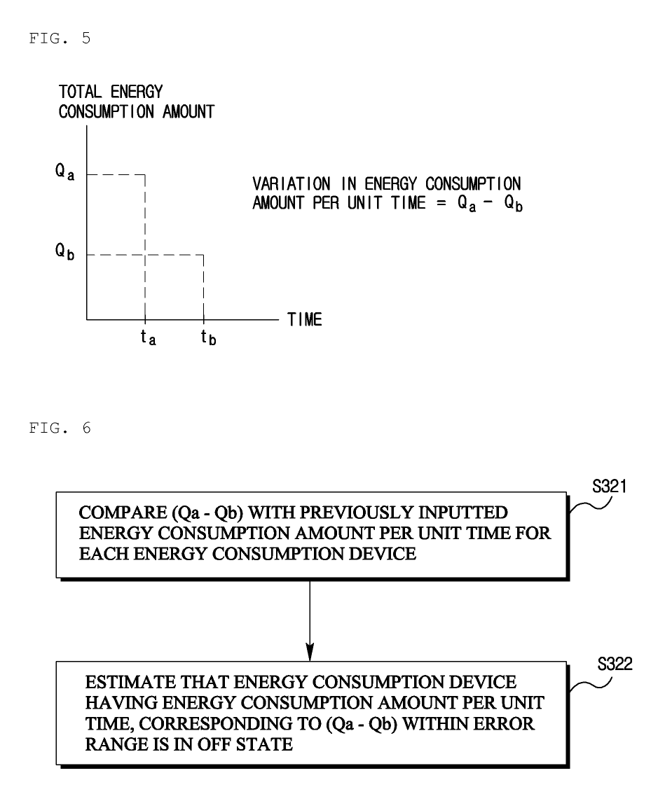

As shown in FIG. 4, the estimation component 21 compares the ‘Qb−Qa’ with information on the previously inputted energy consumption amount per unit time for each of the energy consumption devices (S311). Then, the estimation component 21 searches for an energy consumption device having an energy consumption amount per unit time, corresponding to the ‘Qb−Qa’ within an error range, and estimates that the corresponding energy consumption device is in an OFF state and then changed into an ON state at the time ‘ta’ (S312).

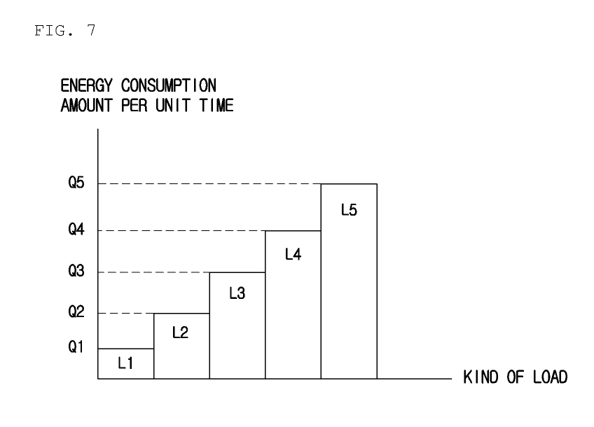

Referring to FIG. 5, when the total energy consumption amount detected at a time ‘ta’ by the meter 13 is ‘Qa’, the total energy consumption amount detected at another time ‘tb’ by the meter 13 is ‘Qb’, and ‘tb−ta’ is a unit time, the variation in the total energy consumption amount per unit time becomes ‘Qb−Qa’. In this instance, Qa>Qb. Therefore, if the value of the ‘Qb−Qa’, which is a negative (−) value, is changed into a positive (+) value, the variation in the total energy consumption amount per unit time becomes ‘Qa−Qb’.

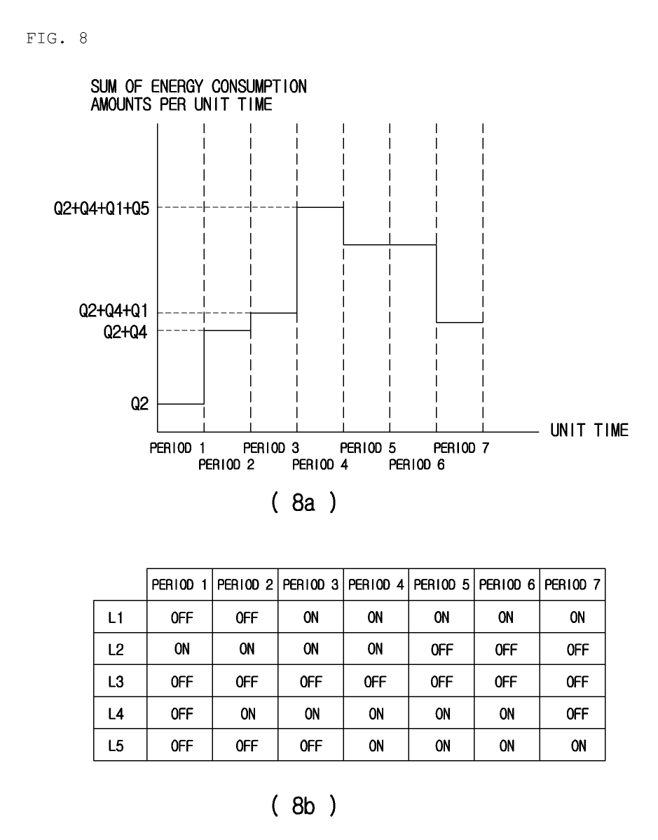

As shown in FIG. 6, the estimation component 21 compares the ‘Qa−Qb’ with information on the previously inputted energy consumption amount per unit time for each of the energy consumption devices (S321). Then, the estimation component 21 searches for an energy consumption device having an energy consumption amount per unit time, corresponding to the ‘Qa−Qb’ within an error range, and estimates that the corresponding energy consumption device is in an ON state and then changed into an OFF state at the time ‘ta’ (S322).

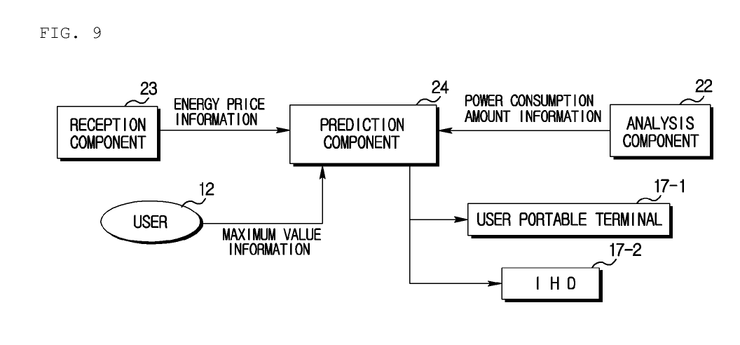

A specific example in which the estimation component 21 estimates an operating state of each of the energy consumption devices 16-1 to 16-k will be described with reference to FIGS. 7 and 8.

FIG. 7 shows energy consumption amounts per unit time for energy consumption devices L1 to L5. The energy consumption devices L1 to L5 are devices that use electric energies of Q1 to Q5 per unit time, respectively.

As described above, information that the energy consumption devices L1 to L5 are devices that use electric energies of Q1 to Q5 per unit time, respectively, may be previously inputted in the manufacture of the system, or may be configured to be inputted by the user.

FIG. 8A shows a fluctuation state of the total energy consumption amount detected by the meter 13 in each period. Here, each of the periods is a unit time period.

The total energy consumption amount per unit time in period 1 is Q2, and the total energy consumption amount per unit time in period 2 is ‘Q2+Q4’.

That is, in FIG. 8A, the variation in the total energy consumption amounts per unit time for periods 1 and 2 is Q4. Therefore, when comparing the Q4 with the previously inputted energy consumption amount per unit time for each of the energy consumption devices, the estimation component 21 can estimate that the operating state of the energy consumption device L4 at the starting time of period 2 has been changed from an OFF state to an ON state.

The total energy consumption amount per unit time in period 3 is ‘Q2+Q4+Q1’.

That is, in FIG. 8A, the variation in the total energy consumption amount per unit time for periods 2 and 3 is Q1. Therefore, when comparing the Q1 with the previously inputted energy consumption amount per unit time for each of the energy consumption devices, the estimation component 21 can estimate that the operating state of the energy consumption device L1 at the starting time of period 3 has been changed from an OFF state to an ON state.

Similarly, if the total energy consumption amount per unit time in period 5 of FIG. 8A is decreased by Q2, the estimation component 21 can estimate that the operating state of the energy consumption device L2 at the starting time of period 5 has been changed from an ON state to an OFF state.

As described above, the estimation component 21 can estimate the operating state of each of the energy consumption devices by comparing the variation in the total energy consumption amounts with the previously inputted energy consumption amount per unit time for each of the energy consumption devices.

FIG. 8B shows a result obtained by estimating operating states of the energy consumption devices L1 to L5 through the aforementioned method using the estimation component 21.

The analysis component 22 analyzes the power consumption amount of an individual energy consumption device based on the consumption time of each of the energy consumption device.

That is, since information on the operating state of each of the energy consumption devices is estimated through the estimation component 21 as described above, the consumption time of each of the energy consumption devices can be detected through the information, and the power consumption amount can be analyzed using the consumption time of each of the energy consumption devices and the energy consumption amount per unit time.

The analysis component 22 may analyze various pieces of information that can be detected through the information on the operating state of each of the energy consumption devices, such as the energy consumption amount per unit time or accumulated energy consumption amount for an individual energy consumption device.

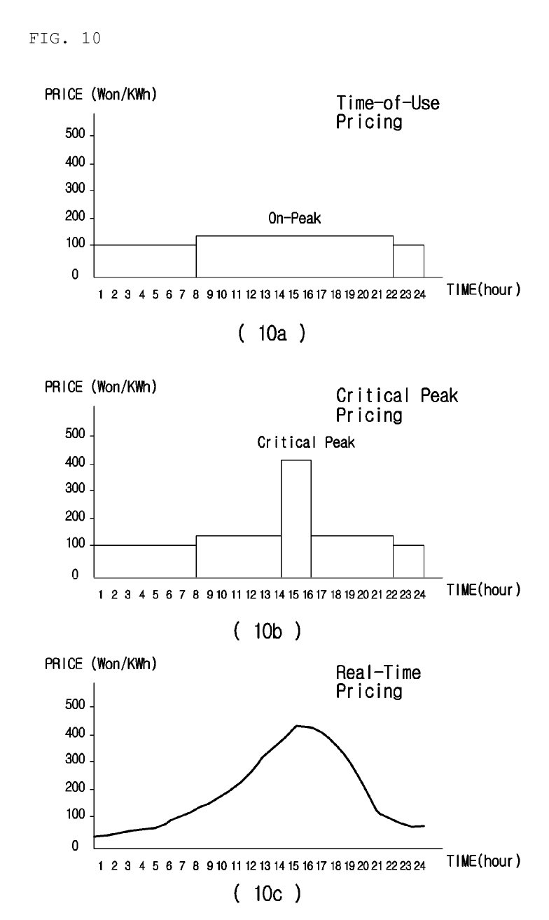

Referring to FIG. 9, the prediction component 24 predicts a current or future energy consumption rate for each of the energy consumption devices based on power consumption amount information of each energy consumption devices, analyzed through the analysis component 22 and energy price information.

The prediction component 24 basically predicts the energy consumption rate of an individual energy consumption device. However, if necessary, the prediction component 24 may predict the total energy consumption rate by summing energy consumption rates of individual energy consumption devices.

The reception component 23 may receive the energy price information from the central server 15, or the energy price information may be inputted by a user 12. In the embodiment in which the central server 15 performs the function of the prediction component 24 as shown in FIG. 2, energy price information of a price information database 15-1 may be used.

The energy price may have various structures. If the energy price is fixed, the energy price information has a simple structure such as won/KWh, won/KVarh or won/KVAh.

However, the energy price may be changed depending on an energy consumption amount or time in accumulated pricing, time of use pricing, critical peak pricing, real-time pricing, or the like.

The following table 1 shows an example of the accumulated pricing in which the unit price is increased as the energy consumption amount is increased.

TABLE 1

| | First | Second | Third | Fourth | |
|---|---|---|---|---|---|
| Period | period | period | period | period | . . . |
| Accumulated | ~100 | 101~200 | 201~300 | 301~400 | . . . |
| consumption | | | | | |
| amount [KWh] | | | | | |
| Unit price | 55.10 | 113.80 | 168.30 | 248.60 | . . . |
| [won/KWh] | | | | | |

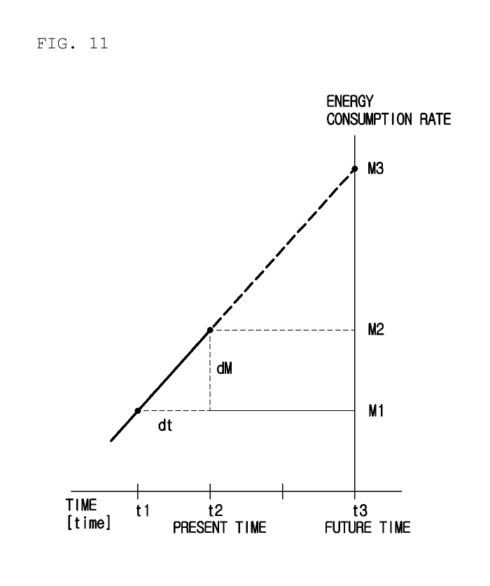

FIG. 10A shows a time of use (TOU) pricing frequently used in arcades, factories, large-scale buildings, in which the price of electricity is changed depending on time zone. FIG. 10B shows a critical peak pricing (CPP) in which the price of electricity is changed depending on time zone, and particularly, the price of electricity in a peak period is very high. FIG. 10C shows a real-time pricing (RTP) in which the price of electricity is changed in real time.

The prediction component 24 may predict a current energy consumption rate of an individual energy consumption device using the following equation 1.

$$M ( k ) = {Q}_{i = 1} [ Q ( k , i ) sP ( i ) ] \qquad [ Equation 1 ]$$

where, ‘k’ denotes a variable for distinguishing energy consumption devices, ‘i’ denotes a variable for distinguishing unit times at which an energy consumption device #k is under operation, M(k) denotes an energy consumption rate for the energy consumption device #k, Q(k, i) denotes an energy consumption amount in a time period ‘i’, and P(i) denotes an energy price in the time period ‘i’.

The total energy consumption rate MT for all the energy consumption devices may be predicted by the following equation 2.

$$MT = {Q}_{k = 1}^{n} M ( k ) \qquad [ Equation 2 ]$$

where, ‘n’ denotes a number of energy consumption devices, ‘k’ denotes a variable for distinguishing energy consumption devices, and M(k) denotes an energy consumption rate for the energy consumption device #k.

The prediction component 24 may calculate energy consumption rates of an individual energy consumption device or total energy consumption rates of the energy consumption devices at minimum two times through the equations 1 and 2 and predict a future energy consumption rate based on the variation rate in the calculated energy consumption rate.

Here, the future time intended to predict the energy consumption rate may be set to a unit such as a day, week, month or year, or may be set to a specific future time. In the latter case, the specific future time may be a time, e.g., the last day in each month, specified so that the user settles the energy consumption rate.

The method for predicting a future energy consumption rate using the prediction component 24 may be variously configured. Particularly, the future energy consumption rate may be predicted using a primary linear function or using a secondary or higher-order non-linear function.

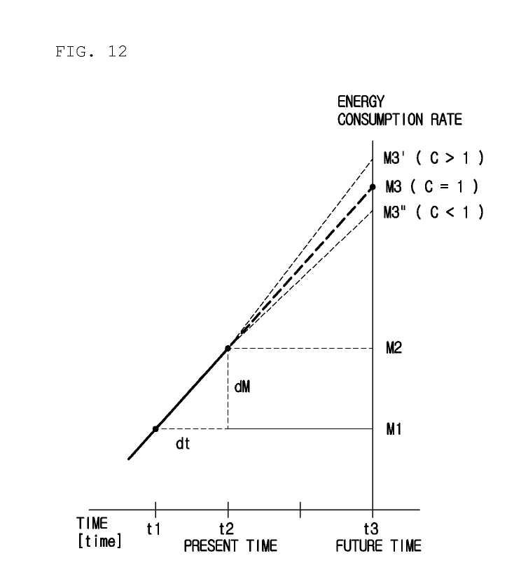

Various methods for estimating a future energy consumption rate using the prediction component 24 will be described with reference to FIGS. 11 to 14.

It is assumed that the energy consumption rate (the energy consumption rate of an individual energy consumption device or the total energy consumption rate of energy consumption devices) at a past time t1 is M1, the energy consumption rate at a current time t2 after a certain time elapses from the past time t1 is M2, and the energy consumption rate at a future time, intended to predict, is M3.

Then, the variation in the energy consumption rate may be calculated as dM, and the variation rate in the energy consumption rate may be calculated as ‘dM÷dt’.

Here, dM is ‘M2−M1’, and dt is ‘t2−t1’.

FIG. 11 shows an example using a linear method so as to predict a future energy consumption rate. The energy consumption rate M3 at the future time t3 may be predicted by the following equation 3.

$$M 3 = M 2 + \frac{d M}{d t} s ( t 3 - t 2 ) \qquad [ Equation 3 ]$$

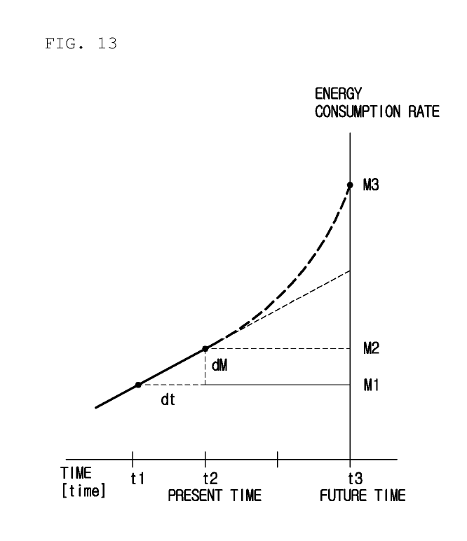

FIG. 12 shows an example using a weighted value so as to predict a future energy consumption rate. The method using the weighted value may be variously configured.

A method may be used as one example, in which a weighted value ‘C’ is applied to a value greater than 1, a value of 1, or a value smaller than 1 according to the variation rate in the energy consumption rate. In this instance, the energy consumption rate M3 at the future time t3 may be predicted by the following equation 4.

$$M 3 = M 2 + Cs \frac{d M}{d t} s ( t 3 - t 2 ) \qquad [ Equation 4 ]$$

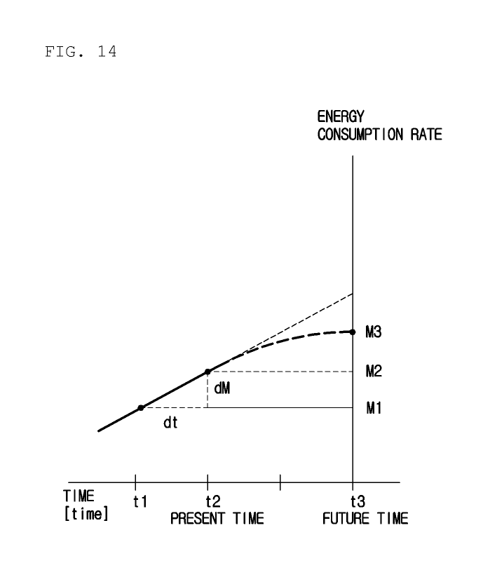

FIG. 13 shows an example using an exponential curve so as to predict a future energy consumption rate. The energy consumption rate M3 at the future time t3 may be predicted by the following equation 5.

M3=M2+(e^{a(t3-t2)}1) [Equation 5]

where, ‘a’ may be determined based on the accumulated pricing of the energy price or the variation rate in the energy consumption rate.

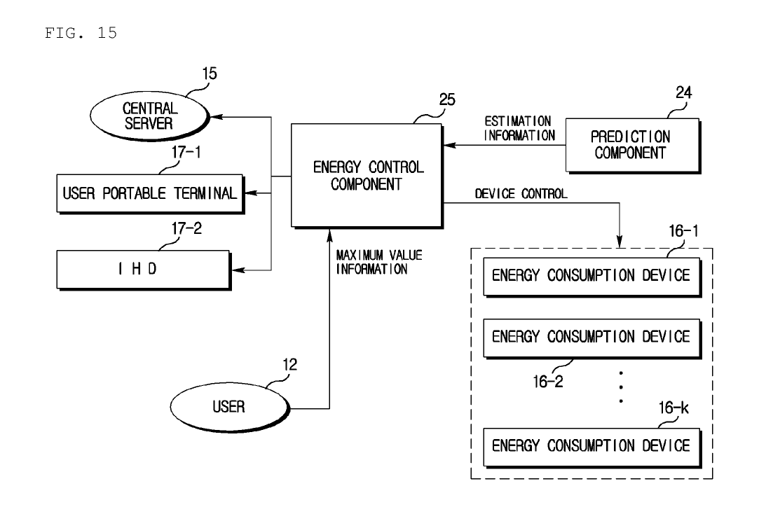

FIG. 14 shows an example using a logarithmic curve so as to predict a future energy consumption rate. The energy consumption rate M3 at the future time t3 may be predicted by the following equation 6.

M3=M2+ln(a(t3−t2)+1) [Equation 6]

where, ‘a’ may be determined based on the accumulated pricing of the energy price or the variation rate in the energy consumption rate.

Meanwhile, the prediction component 24 may predict a rate to be actually charged to the user based on the current or future energy consumption rate using information on the rate imposition policy of the energy supply company 11.

The rate imposition policy of the energy supply company 11 may be variously determined as occasion demands. The rate imposition policy may include a basis rate, a tax, a power factor rate, a rate benefit, and the like.

The tax may include a value-added tax, various funds, and the like. The rate benefit means that a specific industry, e.g., a knowledge service industry has a cheaper power rate than other industries.

As a specific example, the rate actually charged to the user may be calculated as ‘power rate+additional rate’. In this instance, the power rate may be calculated as ‘power consumption amount×unit price+basis rate’, and the additional rate may be calculated as ‘electric power industry basis fund+added-value tax’. The electric power industry basis fund may be set as 3.7% of the power rate, and the added-value tax may be set as 10% of the power rate.

Here, the ‘power consumption amount×unit price’ that determines the power rate is a value predicted through the equations 1 to 6.

The prediction component 24 may transmit the information on the energy consumption rate of an individual energy consumption device or the total energy consumption rate of energy consumption devices to the central server 15, a user portable terminal 17-1, an in home display (IHD) 17-2, and the like.

The prediction component 24 may be configured to monitor whether or not the predicted energy consumption rate or total energy consumption rate exceeds a maximum value set by the user 12.

In this embodiment, the prediction component 24 may provide a user interface (UI) that enables the user 12 to set maximum value information, or may receive the maximum value information set by the user from another device.

If the predicted energy consumption rate or total energy consumption rate exceeds the maximum value, the prediction component 24 may transmit a warning message to the user portable terminal 17-1, the IHD 17-2, or the like.

The prediction component 24 may transmit the warning message through various communication interfaces such as a near field communication network or Internet network. Particularly, the prediction component 24 may transmit the warning message to a user cellular phone through a mobile communication network.

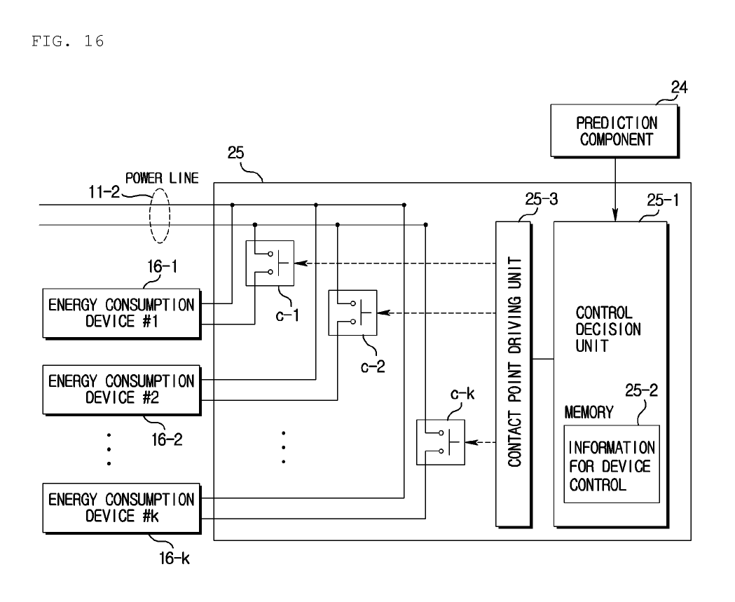

Referring to FIG. 15, the energy control component 25 controls the energy consumption devices 16-1 to 16-k using the information predicted by the prediction component 24.

The method for performing control on the energy consumption devices 16-1 to 16-k using the energy control component 25 may be variously configured as occasion demands.

For example, the method may include a method for cutting off power of an energy consumption device of which estimated energy consumption rate exceeds the previously set maximum value, a method for preferentially cutting off power of an energy consumption device having a high energy consumption rate or low energy efficiency when the total energy consumption rate exceeds the maximum value, and the like.

Information for various devices, necessary for the operation of the energy control component 25 may be inputted by the user. Here, the information includes a maximum value for controlling an energy consumption device, energy efficiency, or the like.

The energy control component 25 may provide a UI that enables the user to input information for device control, or may receive the information for device control from another device.

The control of supplying or cutting off energy to or from each of the energy consumption devices may be performed using a direct control method of the energy consumption device.

FIG. 16 shows an example in which the energy control component 25 directly controls a contact point of a power line 11-2 provided to each of the energy consumption devices 16-1 to 16-k. The energy control component 25 includes a contact points c-1 to c-k at which the power lines 11-2 are connected or opened corresponding to the respective energy consumption devices 16-1 to 16-k, a contact point driving unit 25-3 and a control decision unit 25-1.

The control decision unit 25-1 selects an energy consumption device to be controlled using the information for device control, stored in a memory 25-2, and issues a command that allows the contact point driving unit 25-3 to connect or open a contact point corresponding to the selected energy consumption device. Then, the contact point driving unit connects or opens the corresponding contact point under the command.

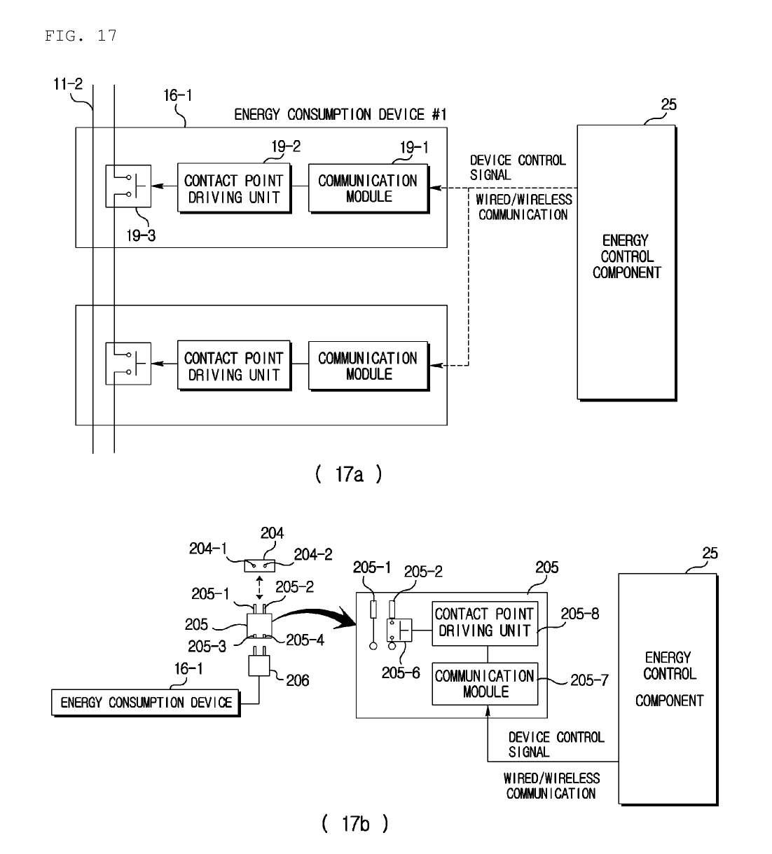

FIG. 17 shows an example in the energy control component 25 controls an energy consumption device using various types of communication interfaces including a wired serial communication interface such as RS-485, a wireless near field communication interface, and the like.

Referring to FIG. 17A, each of the energy consumption devices 16-1 to 16-k is provided with a contact point 19-3, a contact point driving unit 19-2 and a communication module 19-1.

If the energy control component 25 transmits a device control signal for controlling power to a specific energy consumption device 16-1, the communication module 19-1 of the corresponding energy consumption device receives the device control signal transmitted by the energy control component 25. The communication module 19-1 transfers the received device control signal to the contact point driving unit 19-2, and the contact point driving unit 19-2 connects or opens the contact point for power of the corresponding energy consumption device.

FIG. 17B shows an example in which the energy control component 25 controls a third device 205 (hereinafter, referred to as a power switch device) to which a power plug 206 of the energy consumption device using the wireless near field communication interface. The power plug 206 of each of the energy consumption devices is connected to an outlet 204 through the power switch device 205.

The power switch device 205 may be configured to have fastening pins 205-1 and 205-2 capable of being attached/detached to/from a wall outlet or fastening holes 204-1 and 204-2 of the multi-outlet connected to the wall outlet. The power switch device 205 may also be configured to have fastening holes 205-3 and 205-4 capable of being connected to the power plug 206 of the energy consumption device

If the energy control component 25 transmits a device control signal for controlling power to the corresponding energy consumption device, a communication module 205-7 of the corresponding power switch device 205 receives the device control signal transmitted by the energy control component 25 and transfers the received device control signal to a contact point driving unit 205-8. Then, the contact point driving unit 205-8 connects or opens a contact point 205-6 for power of the corresponding energy consumption device.

The energy control component 25 may be configured to transmit a control result for each of the energy consumption devices 16-1 to 16-k to the central server 15, the user portable terminal 17-1, IHD 17-2, and the like.

The energy control component 25 may transmit the control result through various wired or wireless communication interfaces. Particularly, the energy control component 25 may transmit the control result to the user cellular phone through a mobile communication network.

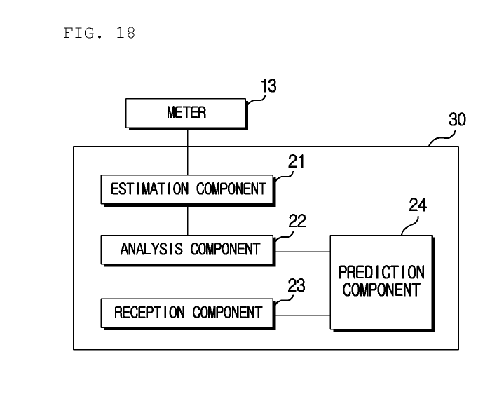

FIG. 18 shows an example. The apparatus 30 for energy management includes at least an estimation component 21, an analysis component 22, a reception component 23 and a prediction component 24.

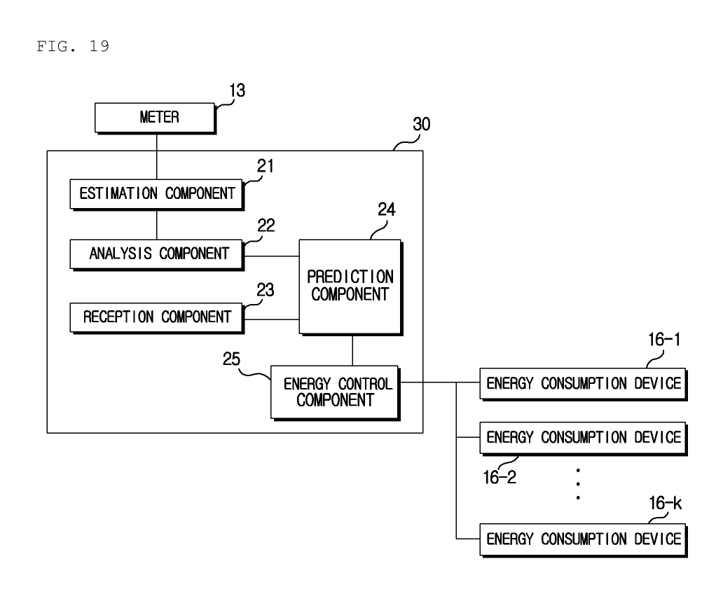

FIG. 19 is another embodiment of the apparatus 30 for energy management according to the present invention. The apparatus 30 may further include an energy control component 25 for controlling each of the energy consumption devices 16-1 to 16-k in the energy consumption place according to the result predicted by a prediction component 24.

The apparatus 30 may be configured as a portion of a meter 13, or may be configured as a separate apparatus different from the meter 13.

At least one of an estimation component 21, an analysis component 22, a reception component 23, the prediction component 24 and the energy control component 25, which constitute the apparatus 30 may be configured as a single component to perform its function while communicating with the other components

The estimation component 21, the analysis component 22, the reception component 23, the prediction component 24 and the energy control component 25, which constitute the apparatus 30, perform functions identical to those of the aforementioned apparatus, and therefore, overlapping descriptions will be omitted.

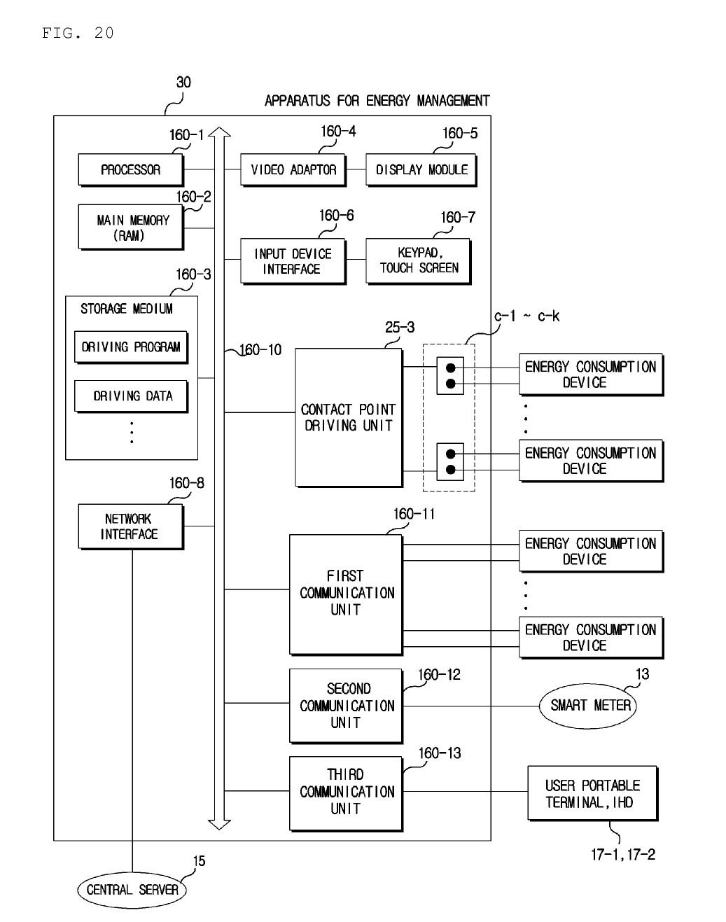

A specific embodiment of the apparatus 30 configured separately from the meter will be described with reference to FIG. 20.

A processor 160-1 may be configured using a central processing unit (CPU), microprocessor or the like. The processor 160-1 generally controls the apparatus 30 while transmitting and receiving information to and from each of the components through a system bus 160-10.

A random access memory (RAM) 160-2 temporarily stores computer programs or data to be immediately accessed by the processor 160-1.

A video adaptor 160-4 visually outputs an operating state of the apparatus or information to be provided to a user through a display module 160-5, and the display module 160-5 may have various forms and structures including a liquid crystal display (LCD), a light emitting diode (LED), and the like.

An input device interface 160-6 enables a user to input information or command related to the operation of the apparatus 30 using various input devices 160-7 such as a keypad and a touch screen.

The user may input information necessary for the operation of the apparatus 30 through the input device 160-7. Here, the information includes information on the energy consumption amount per unit time for each of the energy consumption devices, information on the maximum value of an energy consumption rate, which becomes a control reference of the energy consumption device, and the like.

A network interface 160-8 enables the apparatus 30 to communicate with other servers through a communication network.

The central server 15 described above may be used as an example of such servers, and the apparatus 30 may receive energy price information depending on time from the central server 15.

As shown in the example of FIG. 16, the contact point driving unit 25-3 functions to connect or open contact points c-1 to c-k of the power lines, connected to the respective energy consumption devices.

A first communication unit 160-11 functions to transmit a device control signal to each of the energy consumption devices, connected thereto through a communication interface.

A second communication unit 160-12 is connected to the meter 13 so as to receive energy consumption amount information and the like from the meter 13.

A third communication unit 160-13 interfaces with the user portable terminal 17-1 or IHD 17-2. The third communication unit 160-13 functions to transmit various pieces of energy management information including a predicted energy consumption rate, a warning message and the like.

The first, second and third communication units 160-11, 160-12 and 160-13 may have various communication interface structures necessary for wired serial communication, wireless near field communication, power line communication, and the like.

Particularly, the third communication unit 160-13 may be configured to communicate with the user portable terminal through a wide area network (WAN) such as a mobile communication network.

A storage medium 160-3 stores and maintains driving programs and various data necessary for the operation of the apparatus 30.

The function of the storage medium 160-3 may be performed by a read only memory (ROM). However, the storage medium necessarily has the property of nonvolatility capable of reading and writing digital data so as to store information that is stored or deleted at any time and maintained regardless of the presence of supply of power. If necessary, the storage medium may have various structures and performances including internal, external, separated, non-separated storage media, and the like.

The driving program stored in the storage medium 160-3 is a computer program that enables the apparatus 30 to perform its function.

The driving program may be variously configured. The driving program includes a program module that enables the apparatus 30 to perform the function of the estimation component 21, a program module that enables the apparatus 30 to perform the function of the analysis component 22, a program module that enables the apparatus 30 to perform the function of the reception component 23, a program module that enables the apparatus 30 to perform the function of the prediction component 24, and a program module that enables the apparatus 30 to perform the function of the energy control component 25.

If the operation of the apparatus 30 is started, the processor 160-1 stores the driving program stored in the storage medium 160-3 into the main memory unit 160-2 and then executes the driving program stored in the main memory unit 160-2, so as to control the apparatus 30 to be operated according to the function of each of the components.

FIG. 20 is a mere example of the configuration of the apparatus 30. The apparatus 30 may be variously configured as occasion demands.

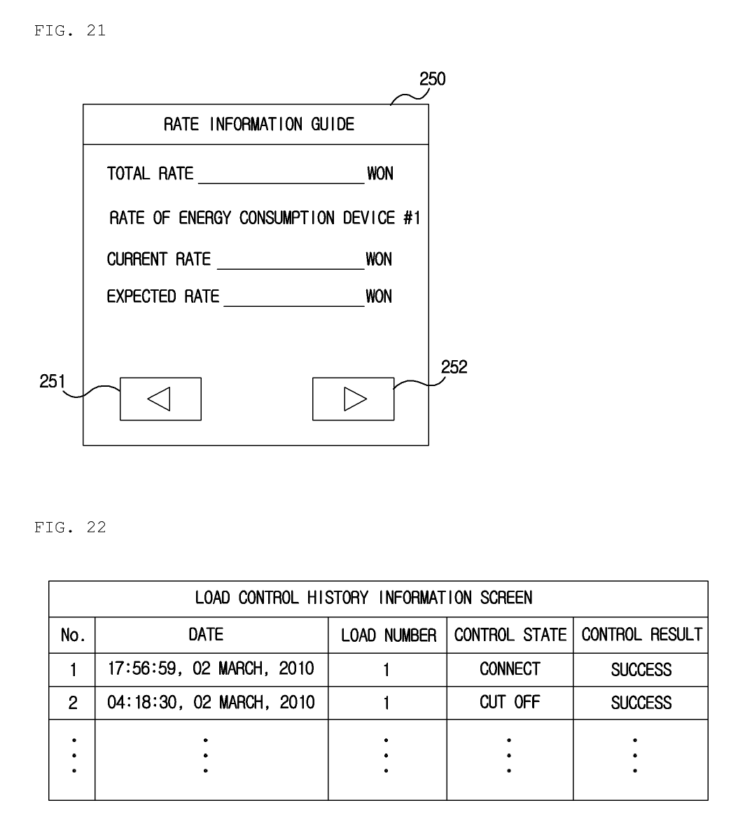

FIG. 21 shows an example of a display screen 250 on which energy consumption information is displayed. In addition to information the total energy consumption rate, information on the energy consumption rate of an individual energy consumption device is displayed on the display screen 250.

Information on current and future energy consumption rates of the energy consumption device #1 is displayed on the display screen 250. The user can identify information on the energy consumption rate of the previous or next energy consumption device by operating directional buttons 251 and 252.

The display screen may be outputted through various types of devices. For example, the display screen may be outputted through the display module 160-5 shown in FIG. 20, or may be outputted through the user portable terminal 17-1, the IHD 17-2, or the like.

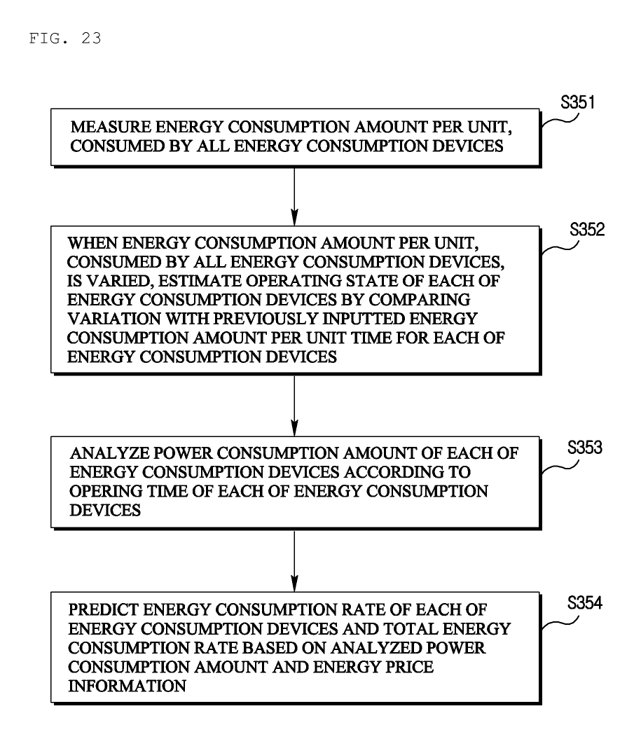

FIG. 22 shows an example of a screen that provides control history information of each of the energy consumption devices. On the screen is shown control history information in that the power of the first load is cut off at 04:18:30, 2 Mar., 2010 and then the power of the first load is again connected at 17:56:59, 2 Mar., 2010.

The screen may also be outputted through the display module 160-5 shown in FIG. 20, or may be outputted through the user portable terminal 17-1, the IHD 17-2, or the like.

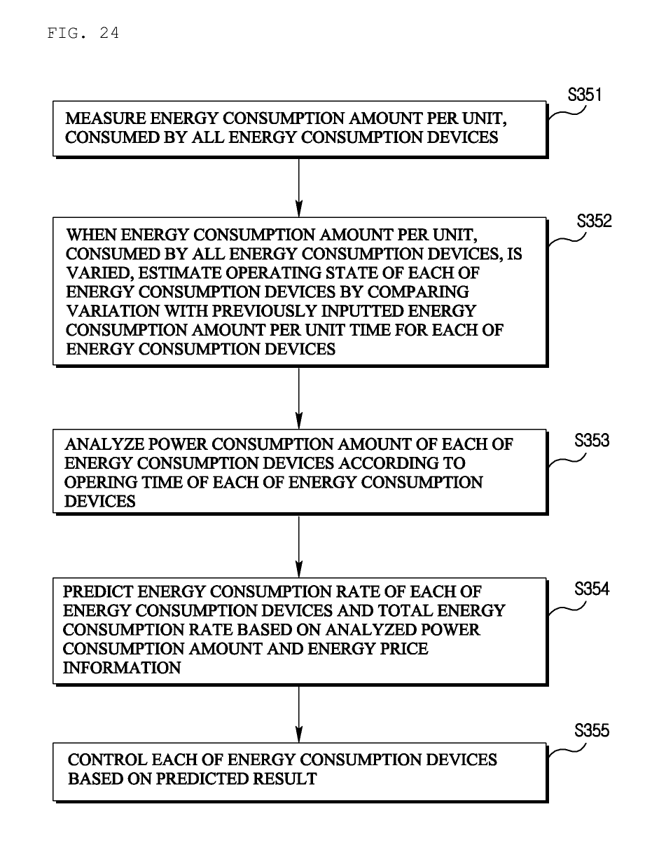

Hereinafter, embodiments of a method for energy management according to the present invention will be described with reference to FIGS. 23 and 24.

Referring to FIG. 23, the apparatus or system for energy management according to the present invention first measures a total energy consumption amount per unit time for all energy consumption devices through a meter (S351).

The operation S351 may be performed in a smart meter.

If the total energy consumption amount per unit time is varied the result measured at the operation S351, the apparatus estimates the operating state of each of the energy consumption devices by comparing the variation with the energy consumption amount per unit time for each of the energy consumption devices (S352).

The method for estimating the operating state of each of the energy consumption devices in the operation S352 has been described in detail with reference to FIGS. 3 to 8, and therefore, overlapping descriptions will be omitted.

Then, the apparatus detects a consumption time for each of the energy consumption devices according to the operating state of each of the energy consumption devices, estimated in the operation S352, and analyzes the power consumption amount of each of the energy consumption devices using the detected consumption time (S353).

That is, the consumption time of each of the energy consumption devices can be detected through the operating state of each of the energy consumption devices, estimated in the operation S352, and thus the power consumption amount can be analyzed using the consumption time of each of the energy consumption devices and the energy consumption amount per unit time.

Here, the power consumption amount is related to an individual energy consumption device. The power consumption amount may be related to a reference period in which the energy consumption rate is calculated.

For example, if it is assumed that the energy consumption rate is charged for each month, the power consumption amount may be an amount of power consumed by a corresponding energy consumption device up to the present after the energy consumption rate is again calculated.

If the power consumption amount for each of the energy consumption devices is analyzed in the operation S353, the apparatus predicts the energy consumption rate of each of the energy consumption devices or the total energy consumption rate of all the energy consumption devices based on the power consumption amount and energy price information (S354).

In this instance, the energy price information may be received from a central server or may be inputted by a user.

The energy price may be changed depending on an energy consumption amount or time in accumulated pricing, time of use pricing, critical peak pricing, real-time pricing, or the like.

The current energy consumption rate of each of the energy consumption devices in the operation S354 may be predicted using the equation 1, and the total energy consumption rate may be predicted using the equation 2.

In the operation S354, energy consumption rates of each of the energy consumption devices or total energy consumption rates of the energy consumption devices may be calculated at minimum two times through the equations 1 and 2, and a future energy consumption rate may be predicted based on the variation rate in the calculated energy consumption rate.

The method for predicting a future energy consumption rate may be variously configured. Particularly, the future energy consumption rate may be predicted using a primary linear function or using a secondary or higher-order non-linear function.

The operation S354 may be configured to predict a rate to be actually charged to the user based on the current or future energy consumption rate using information on the rate imposition policy of the energy supply company.

In the operation S354, the information on the energy consumption rate of each of the energy consumption devices and the information on the total energy consumption rate may be transmitted to a central server, a user portable terminal, an in home display (IHD), and the like.

The operation S354 may be configured to monitor whether or not the predicted energy consumption rate or total energy consumption rate exceeds a maximum value set by the user.

If the predicted energy consumption rate or total energy consumption rate exceeds the maximum value, a warning message may be transmitted to the user portable terminal, the IHD, or the like.

Referring to FIG. 24, the method for energy management according to the present invention may further include controlling the energy consumption devices based on the energy consumption rate estimated in the operation S354 (S355).

In the operation S355, the method for controlling the energy consumption devices may be variously configured as occasion demands.

For example, the method may include a method for cutting off power of an energy consumption device of which estimated energy consumption rate exceeds the previously set maximum value, a method for preferentially cutting off power of an energy consumption device having a high energy consumption rate or low energy efficiency when the total energy consumption rate exceeds the maximum value, and the like.

Various pieces of information for device control, required in the operation S355 may be configured to be inputted by the user. Here, the information includes the maximum value that becomes a control reference of the energy consumption devices, energy efficiency, or the like.

In this instance, the operation S355 may provide a user interface (UI) that enables the user to input the information for device control, or may receive the information for device control inputted by another device.

The control of supplying or cutting off energy in the operation S355 may be performed using a method directly controlling an energy consumption device or controlling an outlet to which the energy consumption device is connected. A specific example related to this is the same as that described with reference to FIGS. 16 and 17.

The operation S355 may be configured to transmit a control result for the energy assumption device to the user portable terminal, the IHD, or the like.

As described above, the present invention has an advantageous effect in that, it is possible to estimate the operating state of an individual energy consumption device using energy consumption amount information detected by a meter.

If the operating state of each energy consumption device is estimated, the consumption time of the individual energy consumption device can be detected, so that it is possible to predict a current or future energy consumption rate for the individual energy consumption device within a rational range.

Also, each energy consumption device in an energy consumption place such as a household, office or company is individually turned on/off according to the predicted result, so that it is possible to control energy to be effectively used within a limited range.

Also, prediction information is informed to a user, so that it is possible to help the user determine his/her intention related to the use of energy.

Although the present invention has been described in connection with the preferred embodiments, the embodiments of the present invention are only for illustrative purposes and should not be construed as limiting the scope of the present invention. It will be understood by those skilled in the art that various changes and modifications can be made thereto within the technical spirit and scope defined by the appended claims.

What is claimed is:

1. An apparatus for energy management, the apparatus comprising:
an estimation component configured to estimate an operating state of an individual energy consumption device based on an energy variation according to time, detected by a meter;
an analysis component configured to analyze a power consumption amount of the individual energy consumption device base on an analysis of the consumption time of the individual energy consumption device;
a reception component configured to receive energy price information according to time from a central server; and
a prediction component configured to predict an energy consumption rate of the individual energy consumption device based on the power consumption amount of the individual energy consumption device and the energy price information.

2. The apparatus of claim 1, further comprising an energy control component configured to supply or cut off energy to or from the individual energy consumption device based on a predicted result of the prediction component.

3. The apparatus of claim 2, wherein the energy control component directly controls power of an energy consumption device or controls an outlet to which the energy consumption device is connected.

4. The apparatus of claim 2, wherein the energy control component transmits a control result for the energy consumption device to at least one of a user portable terminal and an in home display (IHD).

5. The apparatus of claim 1, wherein the prediction component transmits the predicted energy consumption rate of the individual energy consumption device and a total energy consumption rate to at least one of the central server, the user portable terminal and the IHD.

6. The apparatus of claim 1, wherein the prediction component monitors whether or not at least one of the predicted energy consumption rate of the individual energy consumption device and the total energy consumption rate exceeds a predetermined maximum value.

7. The apparatus of claim 6, wherein the estimation component transmits a warning message to at least one of the user portable terminal and the IHD based on a monitored result.

8. A method for energy management, the method comprising:
estimating an operating state of an individual energy consumption device based on an energy variation according to time, detected by a meter;
analyzing a power consumption amount of the individual energy consumption device base on an analysis of the consumption time of the individual energy consumption device;
receiving energy price information according to time from a central server; and
predicting an energy consumption rate of the individual energy consumption device based on the power consumption amount of the individual energy consumption device and the energy price information.

9. The method of claim 8, further comprising controlling energy by supplying or cutting off the energy to or from the individual energy consumption device based on a predicted result.

10. The method of claim 9, wherein the step of controlling of the energy directly controls power of an energy consumption device or controls an outlet to which the energy consumption device is connected.

11. The method of claim 9, wherein the step of controlling of the energy transmits a control result for the energy consumption device to at least one of a user portable terminal and an IHD.

12. The method of claim 8, wherein the predicted energy consumption rate of the individual energy consumption device and a total energy consumption rate are transmitted to at least one of the central server, the user portable terminal and the IHD.

13. The method of claim 8, wherein, when the predicted energy consumption rate of the individual energy consumption device exceeds a predetermined maximum value, a warning message is transmitted to at least one of the user portable terminal and the IHD based on a monitored result.
